(19) United States
(12) Patent Application Publication
(10) Pub. No.: US 2016/0120190 A1
(43) Pub. Date: May 5, 2016

(54) ROLLER ARRANGEMENT COMPRISING A SCRAPER

(71) Applicant: HAAS FOOD EQUIPMENT GMBH, Wien (AT)

(72) Inventors: JOHANNES HAAS, WIEN (AT); JOSEF HAAS, LEOBENDORF (AT); STEFAN JIRASCHEK, KOENIGSBRUNN (AT); PETER LAMBAUER, HITZENDORF (AT)

(73) Assignee: HAAS FOOD EQUIPMENT GMBH, WEIN (AT)

(21) Appl. No.: 14/891,793

(22) PCT Filed: May 14, 2014
(86) PCT No.: PCT/EP2014/059857

§ 371 Date: Nov. 17, 2015

(30) Foreign Application Priority Data
May 17, 2013 (AT) A416/2013

(51) Int. Cl. A21C 3/02

(52) U.S. Cl. CPC A21C 3/024

(57) ABSTRACT

A roller configuration for forming a flat, rolled-out, continuously conveyed dough strip includes at least one rotatably driven roller and a counter-body. A roller gap for conveying and rolling-out the strip of dough is provided between the roller and the counter-body. A scraper which includes a plate-shaped scraper body is tensioned or clamped on one side and is pressed against the roller in a tensioned manner with a scraper edge on the opposite side. The scraper body includes a bending region and the cross-sectional area of the scraper body in the bending region is smaller than in the region of the scraper edge.

The invention relates to a roller arrangement for forming a flat rolled-out continuously conveyed dough strip, comprising at least one rotatably mounted roller, a counter-body, where a roller gap for supplying and rolling out the dough strip is provided between the roller and the counter-body, a scraper which comprises a plate-shaped scraper body which is clamped on one side and on the opposite side is pressed with its scraping edge in a pre-tensioned manner onto the roller. In particular, the invention also relates to a scraper of the aforesaid type for use in a roller arrangement. The invention further relates to a scraper for a roller arrangement.

Roller arrangements with scrapers have been known for a fairly long time and published in different embodiments.

For example, rollers arranged in pairs are known in which an endless dough strip is thinned and consequently rolled out. In order to scrape, for example, dough residues or the dough strip adhering to the roller, scrapers according to the prior art are used. These are usually designed as sheet metal plates which are pressed in a pre-tensioned manner onto the roller.

Known, for example, are roller arrangements in which sheet metal plates having a thickness of about 0.5 mm are pressed onto the roller. As a result of the elastic pre-tensioning of the plate-shaped scraper plate, the scraper rests at constant pressure over the entire width of the roller. As a result of the elastic pre-tensioning against the roller, small tolerance differences are compensated. A disadvantage of this design is that as a result of the continuous friction between roller and scraper, thin plates are worn relatively rapidly due to wear. As a result, the plate loses the contact on the roller and the functionality is severely impaired. For changing the scraper the entire installation for producing the dough strip and subsequently the entire baking plant must be stopped.

In order to prevent rapid wear of the scraper, according to the prior art scrapers having a greater thickness are used. For example, metal scrapers having a thickness of about 5 mm are used. These are chamfered on the contact surface with the roller so that a flat support and a sharp scraper edge are formed. A disadvantage with this design is that as a result of the relatively large thickness, the area moment of inertia and therefore the bending stiffness of the scraper body are also substantially increased. An elastic pre-tensioning against the roller is thereby only possible by exerting high pressure and large forces. The high pressure between the roller and the scraper in turn results in increased wear and as a result in undesired removal of material of the scraper.

Consequently in roller arrangements with scrapers there is a conflict of aims between on the one hand the elastic tensibility of the scraper against the roller and on the other hand the thickness for increasing the contact area and for reducing abrasion/wear.

It is the object of the invention to resolve this conflict of aims.

The object according to the invention is solved in particular by the features of the independent patent claim.

In particular, it is solved whereby the scraper body has a bending region and that the cross-sectional area of the scraper body in the bending region is smaller than in the region of the scraper edge, that the area moment of inertia of the scraper body in the bending region is smaller than in the region of the scraper edge, that the cross-sectional area of the scraper body in the bending region is smaller than outside the bending region and/or that the area moment of inertia of the scraper body in the bending region is smaller than outside the bending region.

Further advantageous features of the invention are that the scraper body abuts against the roller uninterruptedly in an extensive or linear manner over the entire width adapted for processing the dough strip, that at least one recess is provided in the bending region, that the scraper body is designed as a plate having substantially constant thickness and that the scraper body has at least one recess in the bending region through which the cross-sectional area and the area moment of inertia in the bending region are reduced and/or that that the bending region runs substantially parallel to the scraper edge and is preferably configured to be elongate.

It can further be provided that a plurality of recesses are provided in the bending region, that the recesses are designed as through-openings passing through the plate-shaped scraper body, that the scraper body is clamped along a line running parallel to the scraper edge in a clamping apparatus, that the bending region is provided between the clamping apparatus and the scraper edge and is preferably provided in the central region between the clamping apparatus and the scraper edge and/or that the counter-body is designed as a contra-rotating counter-roller where a scraper according to the preceding description is provided on the counter-roller.

In order to avoid the conflict of aims mentioned initially, the scraper according to the invention has a bending region in which the cross-sectional area and/or the area moment of inertia is/are reduced. Consequently the scraper can be formed from a relatively thick plate which is only affected by wear due to abrasion to a small degree. As a result of the reduction in the area moment of inertia or the cross-sectional area, an advantageous elastic deformability or bending elasticity similar to a very thin scraper body is achieved.

The formation as a substantially plate-shaped scraper body with recesses to reduce the cross-sectional area and/or the area moment of inertia is furthermore a very efficient and therefore cost-effective design.

The apparatus according to the invention comprises a rotatably mounted roller which is positioned at a certain distance from a counter-body. A roller gap for passing the dough strip through is provided between these two elements. Optionally in all embodiments individual substantially non-rigid shaped bodies which are separated from one another can also be passed through. Examples of this are stamped-out biscuit dough shaped bodies for forming biscuits.

The roller is in particular driven rotationally about an axis of rotation. Substantially parallel to this axis of rotation, the scraper body of the scraper has a scraper edge which abuts against the roller. According to a further embodiment of the invention however, the scraper body can also abut obliquely against the roller so that the scraper edge and the axis of rotation of the roller run substantially skew to one another.

A clamping apparatus is provided for holding the scraper body of the scraper. This is for example, designed as a clamping jaw apparatus in which the scraper is clamped between two plates. Preferably the clamping is executed along a linear contact or surface contact running parallel to the scraper edge.

The scraper body is preferably made of a plate-shaped body having a thickness of 0.5 mm to 1 mm. The scraper body is preferably made of metal, in particular of steel, in particular of stainless steel or spring steel. As a result of the reduction in the bending stiffness according to the invention, an optimal abutment of the scraper body is achieved even with low pressing force. As a result, the wear is reduced.

The apparatus according to the invention is suitable and/or adapted to be used “in-line” in an industrial production plant for food products.

Subsequently the invention is further described by reference to the figures.

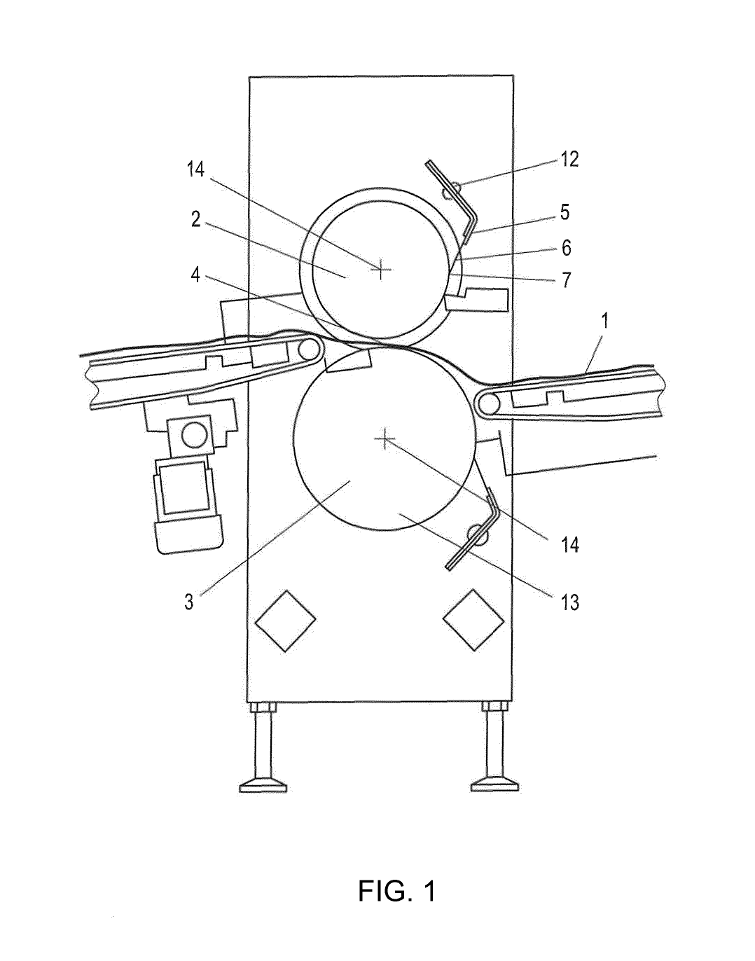

FIG. 1 shows a schematic side view of one embodiment of a design according to the invention where one of the side plate is blanked out.

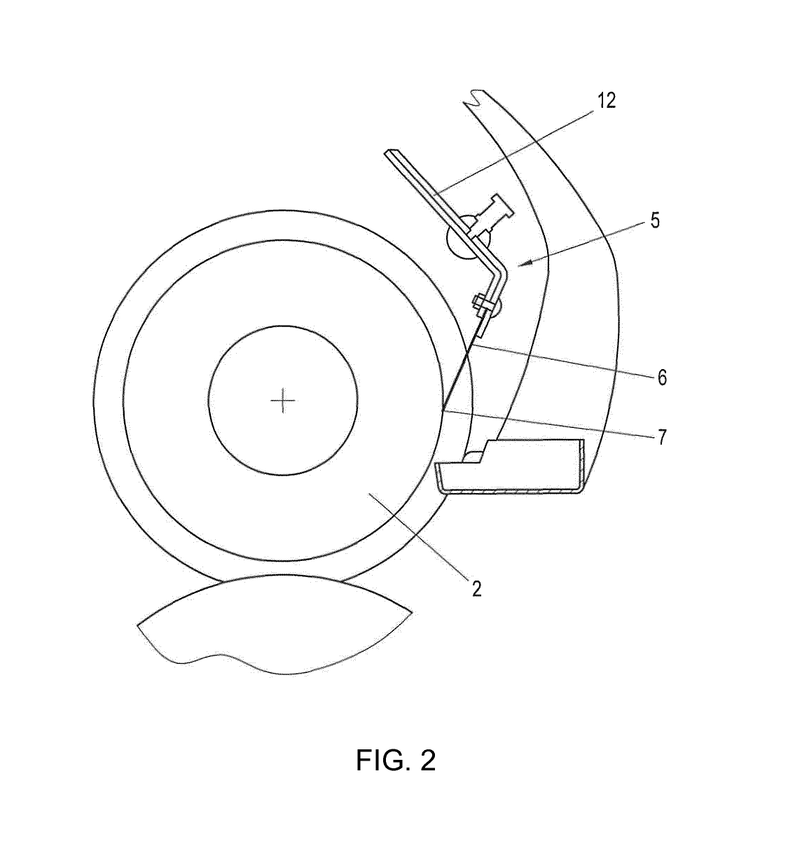

FIG. 2 shows a detail of the scraper of the apparatus according to the invention.

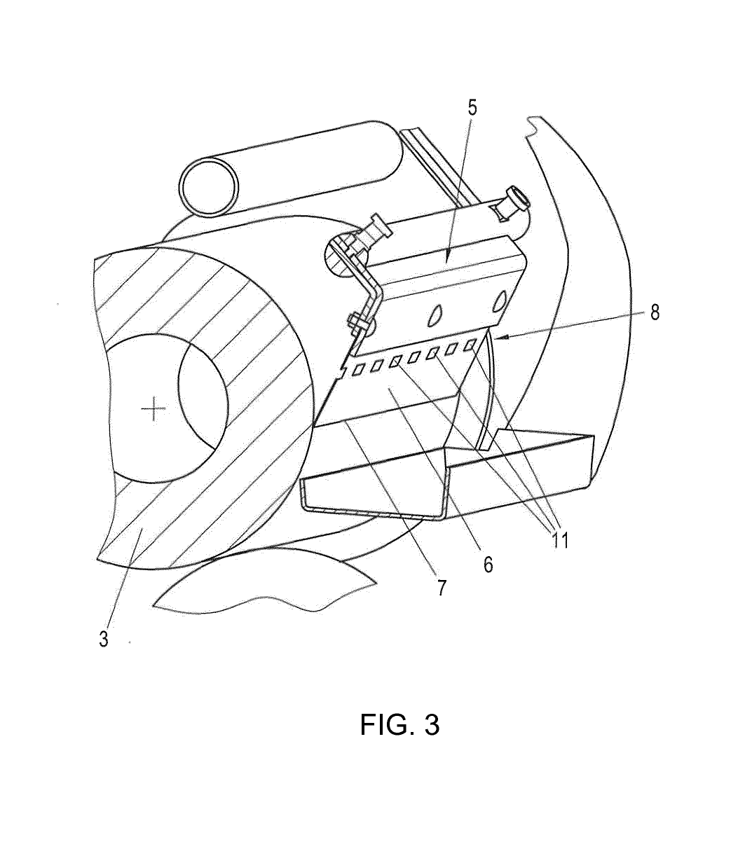

FIG. 3 shows a schematic oblique view of the scraper of the apparatus according to the invention.

FIG. 1 shows an embodiment of an apparatus according to the invention. This comprises a roller 2, a counter-body 3 and a roller gap 4 provided between the roller 2 and the counter-body 3.

A dough strip 1 is guided through the roller gap 4. In the schematic diagram the roller gap is shown wider than is required for rolling out the schematically depicted dough strip. Usually the width of the gap, i.e. the distance of the two rollers, substantially corresponds to the thickness of the emerging dough strip.

In the present embodiment the counter-body 3 is designed as counter-roller 13. However, this counter-body can optionally also be designed as conveyor belt, conveyor surface or similar construction.

The roller 2 and the counter-body 3 are preferably driven so that the dough strip is conveyed through the roller gap. For example, in the present diagram of FIG. 1, a movement of the dough strip 1 from left to right is made possible by the drives of the two rollers.

When starting up roller arrangements it arises that the introduced front end of the dough strip 1 adheres to a roller and is wound up by this. In order to prevent this, a scraper 5 is provided. Adhering dough residues are also released from the roller by the scraper 5. The scraper 5 comprises a substantially plate-shaped scraper body 6 which abuts with its scraper edge 7 against the roller 2. Furthermore the scraper 5 comprises a clamping apparatus 12 which on the one hand serves to stop the scraper body 6 and on the other hand to press the scraper body 6 in a pre-tensioned manner onto the roller 2. To this end, the clamping apparatus 12 comprises a rotatable or pivotable component which can locked in a rotary position in order to press the scraper body in this position onto the roller.

The roller 2 and optionally the counter-roller 13 each have an axis of rotation 14. This axis of rotation 14 runs in a substantially projecting manner in the present view.

FIG. 2 shows a detailed view of the scraper 5 and the roller 2. The scraper 5 comprises a clamping apparatus 12, a scraper body 6 as well as a scraper edge 7, which is placed on the roller 2. The scraper body 6 in the present embodiment is held by the clamping device 12. To this end the clamping apparatus 12 is connected to the machine frame of the roller arrangement. Furthermore the scraper body 6 is pressed by means of the clamping apparatus 12 onto the roller 2. The counterforces or moments which occur are supported by means of the clamping apparatus 12 on the machine frame. In the present embodiment a clamping at the clamping apparatus is accomplished substantially parallel to the scraper edge. As a result, a constant contact force of the scraper body 6 over the entire width of the roller is achieved. In the present view the direction of the “width” of the roller runs substantially in a projecting manner.

FIG. 3 shows the same arrangement as FIG. 2 but in an oblique view. Again a scraper 5 is provided which is pressed against the roller 2 of the roller arrangement. The scraper 5 comprises a scraper body 6. The scraper body 6 is designed to be plate-shaped. It has a substantially rectilinearly running scraper edge 7. This is pressed against the roller 2. Furthermore the scraper 5 has a bending region 8. A plurality of recesses 11 are provided in the bending region 8. In the present embodiment the recesses 11 are also configured as through openings running through the plate. As a result, the cross-sectional area in the bending region 8 is reduced. The cross-sectional areas are those surfaces which are substantially normal to the flat sides of the scraper body and run substantially parallel to the scraper edge. The bending region 8 preferably also runs substantially parallel to the scraper edge 7.

The recesses 11 according to one embodiment are designed to be elongate-hole shaped, where the direction of longitudinal extension thereof preferably runs substantially parallel to the scraper edge 7. However, rectangular, round, oval or different-shaped recesses are also possible.

The recesses are preferably distributed regularly in the bending region. This means, for example, that the pressure between the scraper body and the roller is constant along the course of the scraper edge. Depending on the configuration of the scraper body, optionally a constant application force of the scraper body on the roller is however also achieved due to non-uniformly distributed recesses.

As a direct consequence of the reduction of the cross-sectional areas, the area moment of inertia and therefore the bending stiffness of the entire scraper or the entire scraper body 6 is reduced in the bending region. As a result, the advantageous effect occurs that despite sufficient thickness of the scraper body 6, an optimal bending elasticity is achieved.

According to a further embodiment not shown, the recesses 11 are formed as a continuous groove or by a plurality of indentations. The cross-sectional area of the scraper body 6 in the bending region 8 is also reduced as a result of these types of recesses. Consequently the area moment of inertia in the bending region 8 or the bending elasticity of the scraper body 6 is optimized.

Preferably the bending region 8 is provided in a region between clamping apparatus 12 and scraper edge 7.

### REFERENCE LIST

1 Dough strip

2 Roller

3 Counter-body

4 Roller gap

5 Scraper

6 Scraper body

7 Scraper edge

8 Bending region

9 Roller axis

10 Cross-sectional area

11 Recess

12 Clamping apparatus

13 Counter-roller

14 Axis of rotation

1-10. (canceled)

11. A roller configuration for forming a flat rolled-out continuously conveyed dough strip, the roller configuration comprising:
at least one rotatably driven roller and a counter-body defining a roller gap for supplying and rolling out the dough strip between said roller and said counter-body;
a scraper including a plate-shaped scraper body, said scraper body having one side, an opposite side, a scraper region with a scraper edge on said opposite side and a bending region with at least one recess formed therein;
said one side of said scraper body being clamped and said scraper edge on said opposite side of said scraper body being pressed and pre-tensioned onto said roller; and
said scraper body having a cross-sectional area in said bending region being smaller than a cross-sectional area in said region of said scraper edge.

12. The roller configuration according to claim 11, wherein said scraper body abuts against said roller uninterruptedly in an extended or linear manner over an entire width adapted for processing the dough strip.

13. The roller configuration according to claim 11, wherein said scraper body is a plate having a substantially constant thickness, and said at least one recess formed in said bending region reduces a cross-sectional area and an area moment of inertia in said bending region.

14. The roller configuration according to claim 11, wherein said bending region runs substantially parallel to said scraper edge.

15. The roller configuration according to claim 11, wherein said at least one recess formed in said bending region is a plurality of recesses formed in said bending region.

16. The roller configuration according to claim 15, wherein said recesses are through-openings passing through said plate-shaped scraper body.

17. The roller configuration according to claim 11, which further comprises a clamping apparatus clamping said scraper body along a line running parallel to said scraper edge.

18. The roller configuration according to claim 17, wherein said bending region is provided between said clamping apparatus and said scraper edge.

19. The roller configuration according to claim 17, wherein said bending region is provided in a central region between said clamping apparatus and said scraper edge.

20. The roller configuration according to claim 11, wherein said counter-body is a counter-roller rotating in a direction opposite to said roller, and another scraper is provided on said counter-roller.
